(19) United States
(12) Patent Application Publication
(10) Pub. No.: US 2008/0279404 A1
(43) Pub. Date: Nov. 13, 2008

(54) Surround Sound Headphone

(76) Inventor: Hsin-Yuan Kuo, Kaohsiung County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/114,793

(22) Filed: May 4, 2008

(30) Foreign Application Priority Data
May 8, 2007 (TW) 96207378

(51) Int. Cl. H04R 5/033

(52) U.S. Cl. 381/311; 381/309

(57) ABSTRACT

A surround sound headphone has a plurality of sound-producing planes provided in each of the earpieces of the headphone, and at least one diaphragm arranged on each of the sound-producing planes for producing sounds in directions toward a user's ear, such that the sounds produced by the diaphragms converge at a user's ears, enabling the user to experience a stereo and surround sound effect.

### FIELD OF THE INVENTION

The present invention relates to a surround sound headphone, and more particularly to a headphone having a plurality of sound-producing planes provided in the earpieces of the headphone, so that sounds produced from the sound-producing planes converge in the earpieces at the user's ears.

### BACKGROUND OF THE INVENTION

A headphone is now very popular among people and frequently used by people in their daily life. A conventional headphone usually has one or more diaphragms being arranged on the same one plane in each of the earpieces of the headphone. FIG. 1 is a top view of an earpiece 1 for a conventional headphone. There are two or more diaphragms 2 arranged in the earpiece 1 to separately simulate front and rear sound sources. Since the diaphragms 2 arranged on the same one sound-producing plane produce parallel sounds, there would be errors in the produced surround sound effect. For a user demanding high sound quality, the conventional headphone just could not produce a stereo and surround sound effect good enough to satisfy the user.

Therefore, it is desirable to develop a surround sound headphone that enables produced sounds to converge at the user's ears to create a stereo and surround sound effect.

### SUMMARY OF THE INVENTION

A primary object of the present invention is to provide a surround sound headphone that enables produced sounds to converge at a user's ears, so that the user may experience a real stereo and surround sound effect.

To achieve the above and other objects, the surround sound headphone according to the present invention includes at least one earpiece for wearing on a user's ear; and a plurality of sound-producing planes arranged in the at least one earpiece for each producing a sound in a direction toward the user's ear, such that the produced sounds converge at the user's ear to create a stereo effect.

In the present invention, at least one diaphragm for producing sound is arranged on each of the sound-producing planes, so that sounds produced by the diaphragms converge at the user's ear, enabling the user to experience a stereo and surround sound effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a top view of an earpiece of a conventional headphone;

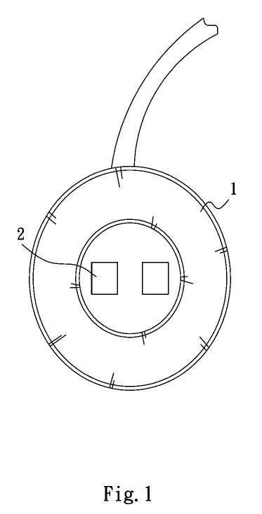

FIG. 2 is a sectional view of a surround sound headphone according to a first preferred embodiment of the present invention being worn on a user's head;

FIG. 3 is a sectional view of a surround sound headphone according to a second preferred embodiment of the present invention being worn on a user's head;

FIG. 4 is a sectional view of a surround sound headphone according to a third preferred embodiment of the present invention being worn on a user's head; and

FIG. 5 is a sectional view of a surround sound headphone according to a fourth preferred embodiment of the present invention being worn on a user's head.

### DETAILED DESCRIPTION OF THE PREFERRED EMBODIMENTS

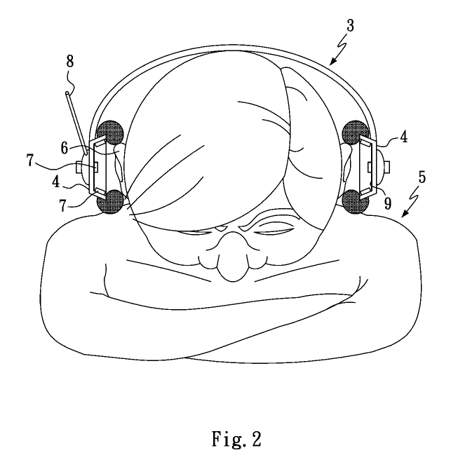

Please refer to FIG. 2 that is a sectional view of a surround sound headphone 3 according to a first preferred embodiment of the present invention being worn on a user's head. As shown, the surround sound headphone 3 of the first embodiment includes at least one earpiece 4 adapted to cover and wear on a user's 5 one ear 6. In the illustrated drawings, there are two earpieces 4 provided on the headphone 3 for covering and wearing on the user's two ears 6, and each of the earpieces 4 has a trapezoidal longitudinal section, so that a plurality of sound-producing planes 9 is provided in each of the earpieces 4 to produce sounds in directions toward the user's ear 6. The sound-producing planes 9 are so arranged in each of the earpieces 4 that sounds produced from these sound-producing planes 9 converge at the user's ear 6. Each of the sound-producing planes 9 includes at least one diaphragm 7 for producing a sound. The surround sound headphone 3 further includes a signal input device 8 for inputting a sound signal to the surround sound headphone 3. In the first preferred embodiment, the signal input device 8 is a wireless signal input device. However, it is understood the signal input device 8 may be otherwise a wired signal input device. Meanwhile, the surround sound headphone 3 further includes a power supply (not shown), such as a battery, for supplying power needed by the headphone 3 to operate; and a sound control device (not shown) for regulating the sound quality or volume of the surround sound headphone 3. Moreover, the surround sound headphone 3 of the present invention is able to receive surround sound signals from various directions and reproduce the received signals via the sound-producing planes 9.

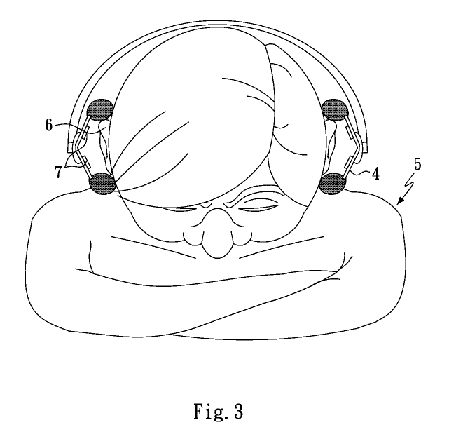

FIG. 3 is a sectional view of a surround sound headphone 3 according to a second preferred embodiment of the present invention being worn on a user's head. As shown, the surround sound headphone 3 in the second embodiment is generally structurally similar to that in the first embodiment, except that the earpieces 4 in the second embodiment each have a V-shaped longitudinal section to provide more than one sound-producing plane in the earpieces 4. The diaphragms 7 in the second embodiment are arranged in the V-sectioned earpieces 4 in the same manner as that in the first embodiment, so that sounds produced by the diaphragms 7 would still converge at the user's ears 6.

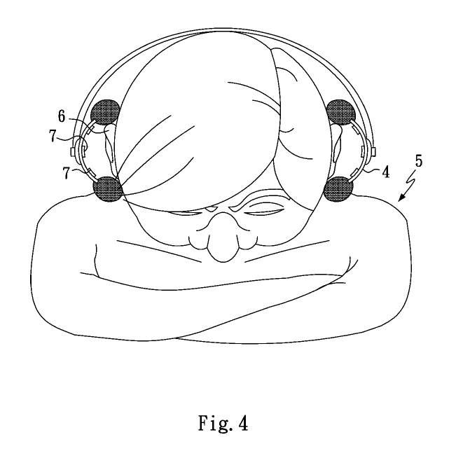

FIG. 4 is a sectional view of a surround sound headphone 3 according to a third preferred embodiment of the present invention being worn on a user's head. As shown, the surround sound headphone 3 in the third embodiment is generally structurally similar to that in the first and second embodiments, except that the earpieces 4 in the third embodiment each have a curve-shaped longitudinal section to provide a concave sound-producing plane in the earpieces 4. The diaphragms 7 in the third embodiment are arranged in the earpieces 4 in the same manner as that in the first and second embodiments, so that sounds produced by the diaphragms 7 would still converge at the user's ears 6.

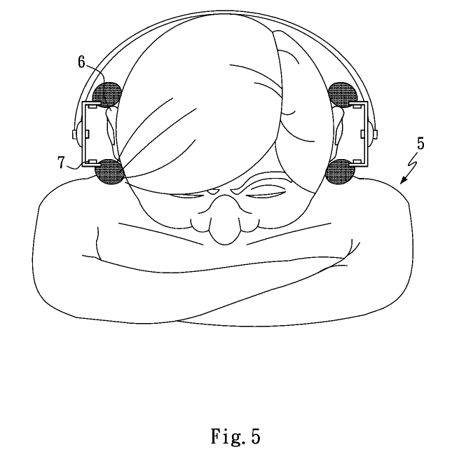

FIG. 5 is a sectional view of a surround sound headphone 3 according to a fourth preferred embodiment of the present invention being worn on a user's head. As shown, the surround sound headphone 3 in the fourth embodiment is generally structurally similar to that in the previous embodiments, except that the earpieces 4 in the fourth embodiment each have a right-angled U-shaped longitudinal section to provide more than on sound-producing plane in the earpieces 4. The diaphragms 7 in the fourth embodiment are arranged in the earpieces 4 in the same manner as that in the previous embodiments, so that sounds produced by the diaphragms 7 would still converge at the user's ears 6.

In brief, the present invention provides a headphone having a plurality of diaphragms being so arranged on the sound-producing planes in each of the earpieces of the headphone that sounds produced by the diaphragms would always converge at the user's ears in the earpieces, enabling the user to experience a real stereo and surround sound effect. Therefore, the present invention is industrially and commercially valuable for use, and products derived from the present invention would doubt satisfy the current market demands.

What is claimed is:

1. A surround sound headphone, comprising:
at least one earpiece for wearing on a user's ear; and
a plurality of sound-producing planes arranged in the at least one earpiece for each producing a sound in a direction toward the user's ear, such that the produced sounds converge at the user's ear; and each of the sound-producing planes including at least one diaphragm for producing sound.

2. The surround sound headphone as claimed in claim 1, wherein the surround sound headphone is able to receive surround sound signals from various directions and reproduce the received signals via the sound-producing planes.

3. The surround sound headphone as claimed in claim 1, further comprising a signal input device for inputting sound signals to the at least one earpiece of the headphone.

4. The surround sound headphone as claimed in claim 3, wherein the signal input device is a wired signal input device.

5. The surround sound headphone as claimed in claim 3, wherein the signal input device is a wireless signal input device.

6. The surround sound headphone as claimed in claim 1, further comprising a power supply for supplying power needed by the headphone to operate.

7. The surround sound headphone as claimed in claim 6, wherein the power supply is a battery.

8. The surround sound headphone as claimed in claim 1, further comprising a sound control device for regulating the produced sounds to a desired quality or volume.
